(19) United States
(12) Patent Application Publication
(10) Pub. No.: US 2009/0136311 A1
(43) Pub. Date: May 28, 2009

(54) DEVICE AND METHOD FOR PRODUCING SLIT DIAPHRAMS FOR HIGH-ENERGY RADIATION

(75) Inventors: KURT OSTERLOH, BERLIN (DE); UWE EWERT, TELTOW (DE); HEINZ-JUERGEN KNISCHEK, BERLIN (DE); UWE ZSCHERPEL, GLIENICKE (DE)

Correspondence Address: NORRIS, MCLAUGHLIN & MARCUS, P.A., 875 THIRD AVE, 18TH FLOOR, NEW YORK, NY, 10022, US

(73) Assignee: BAM BUNDESANSTALT FUER MATERIALFORSCHUNG UND-PRUEFUNG, BERLIN (DE)

(21) Appl. No.: 12/265,020

(22) Filed: Nov. 5, 2008

(30) Foreign Application Priority Data
Nov. 26, 2007 (DE) 10 2007 057 261.3

(51) Int. Cl. B23C 1/14; B23C 9/00; B23C 3/36; B23Q 1/44

(52) U.S. Cl. 409/132; 409/145; 409/165; 409/169

(57) ABSTRACT

To provide a device and a corresponding method for producing a slit diaphragm using a very simple production process, the device includes a cutting tool (12) capable of cutting along a straight line, and means capable of effecting a relative movement between the cutting tool (12) and a workpiece (10), such that the cutting tool (12) cuts the workpiece (10) along a line which corresponds a beam path in the slit diaphragm to be produced.

The invention relates to a device and a method for producing slit diaphragms for high-energy radiation according to the preambles of claims 1 and 13.

An image-forming diaphragm for high-energy radiation and a focal point-oriented rotating cylindrical diaphragm are known from DE 10 2005 029 674.2 and DE 10 2005 048 519.7-54. Both devices have in common that the high-energy radiation can pass through the diaphragms only for certain beam directions, whereas the radiation is absorbed by the diaphragms for all other beam directions. To this end, the diaphragms have suitably curved slits which allows radiation to pass through only in certain straight directions. This type of diaphragms can be used to image high-energy radiation sources, which would not be possible with a simple pinhole diaphragm due to the required layer thickness of the shielding material.

Conventional slit diaphragms are not easy to manufacture. The three-dimensional twisted surfaces require a minimum of precision to ensure homogeneous slit widths of 1 mm or significantly less. Producing the shape and the precision is therefore a dual challenge.

At least a (static) image-forming aperture can be constructed by using programmable milling machines; however, this involves quite complex programming due to the complexity of the shapes. Particularly stringent requirements are placed on the precision if, for example, the intended use is imaging the focal spot of an x-ray tube operating at high-energy (>200 keV). Conventional pinhole apertures cannot be employed, because a pinhole diaphragm cannot be constructed with the required layer thickness. A slit diaphragm can advantageously be constructed with a greater layer thickness without losing its image-forming property (for example, 30 mm for tungsten). Because the focal spot has a size in the millimeter range, slits have to be manufactured with a precision of better than 1 mm. Accordingly, mechanical finish grinding should be considered as an option. Finish grinding with a programmable machine tool requires repeated intervention in the control program.

The aforementioned cylindrical diaphragm cannot be produced with existing machine tools and milling machines, because rotations are also required in addition to movements in Cartesian coordinate space. This is not provided for in conventional systems.

It is an object of the invention to provide a device and a method for producing slit diaphragms which intentionally use only generally available tools and rely on auxiliary equipment that can be constructed from generally available semi-finished products. If precision milling machines and cutting jet systems with at least one defined fixed milling direction are available, then it is a particular object of the invention to identify a holder for the workpiece which is suspended for mechanical control and which is sufficiently stable for the machining operation. This object is attained with the invention by a device having the features recited in claim 1 and by a method having the features recited in claim 13.

A slit diaphragm can be produced with a device according to the invention which includes a cutting tool capable of cutting along a straight line, and means capable of effecting a relative movement between the cutting tool and a workpiece, such that the cutting tool cuts the workpiece along a line which corresponds a beam path in the slit diaphragm to be produced. With this approach, the slit diaphragm passes only beams in predetermined directions while absorbing radiation in other directions. The cutting process can be performed, for example, with an abrasive cutting jet or with a rotating cutting disk which moves linearly on a rail. In a preferred embodiment of the invention, the cutting tool is adapted to cut along a fixed first direction; in particular, the cutting tool is immovable. Preferably, the cutting tool is fixed while the workpiece is moved around it. According to the primary concept underlying this embodiment, rather than clamping the workpiece in a fixed holder and guidingly moving the tool, the workpiece is instead moved in a controlled fashion around a milling cutter or a cutting jet.

The workpiece is generally moved by two movements, which can be mechanically coupled with one another and driven with a single motor. In a mechanical milling process, the motor moves stepwise, whereas with a cutting jet, the motor can also move continuously at correspondingly slower speeds adapted to the milling process.

Preferably, the motor drives as shaft which is fixedly connected to the workpiece by gearwheels with defined gear ratios. In a practical embodiment, this can be a small rotation-speed-controlled electric motor or a conventional drill with adjustable speed or an electric screwdriver. When stepwise mechanical milling with high precision is required, a stepping motor can advantageously be employed which only moves between the individual milling steps. The milling pattern is determined by the mechanical travel and does not need to be programmed separately.

In a preferred embodiment of the invention, the first rotation axis extends along a second direction perpendicular to the cutting direction of the cutting tool, and the means are configured to effect a rotation of the holder about the first rotation axis and simultaneously a translation of the holder along the second direction.

The rotation and the translation of the holder may be linearly coupled.

The means may include a first and a second threaded shaft, both of which extending in the second direction, wherein a rotation of the two threaded shafts is coupled by a gearwheel system.

The first threaded shaft may include a region formed as a worm shaft, with which a holding arm, to which the second threaded shaft is connected, can be moved along the second direction.

According to another preferred embodiment of the invention, the means may be configured to effect a rotation of the holder about the first rotation axis and simultaneously a rotation of the first rotation axis, including the holder, about a second rotation axis.

The two rotations may be linearly coupled with one another.

The second rotation axis may extend along a third direction perpendicular to the cutting direction of the cutting tool.

The means may include a movably supported frame, which is supported for rotation about the second rotation axis, and with the first rotation axis being rotatably supported in the frame. According to the method of the invention, a relative movement between a cutting tool, which is configured to cut along a straight line, and a workpiece is performed in such a way, that the cutting tool cuts the workpiece along a line which corresponds to the beam path in the slit diaphragm to be produced.

Additional embodiments of the invention are recited as additional features in the dependent claims.

Exemplary embodiments of the invention will now be described in more detail with reference to the appended drawings. Preferred construction principles are provided for each of the special diaphragm shapes. Individual embodiments (sizes, aperture angle) can be realized by changing the gear ratios or distances.

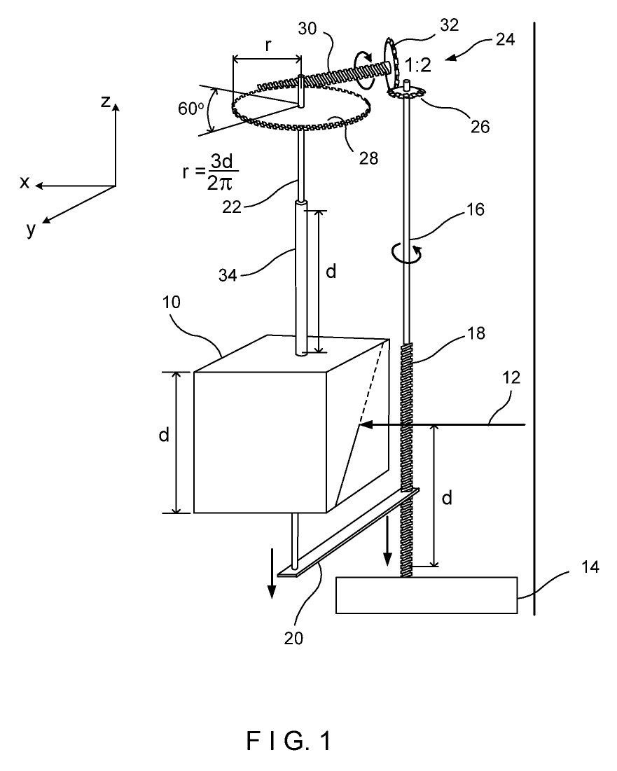

FIG. 1 shows a device for jet milling of a cube-shaped slit diaphragm;

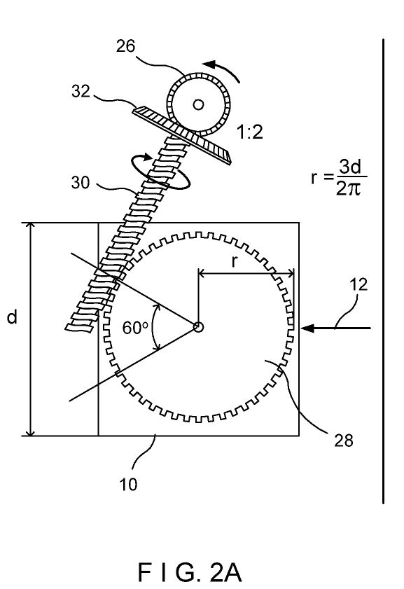

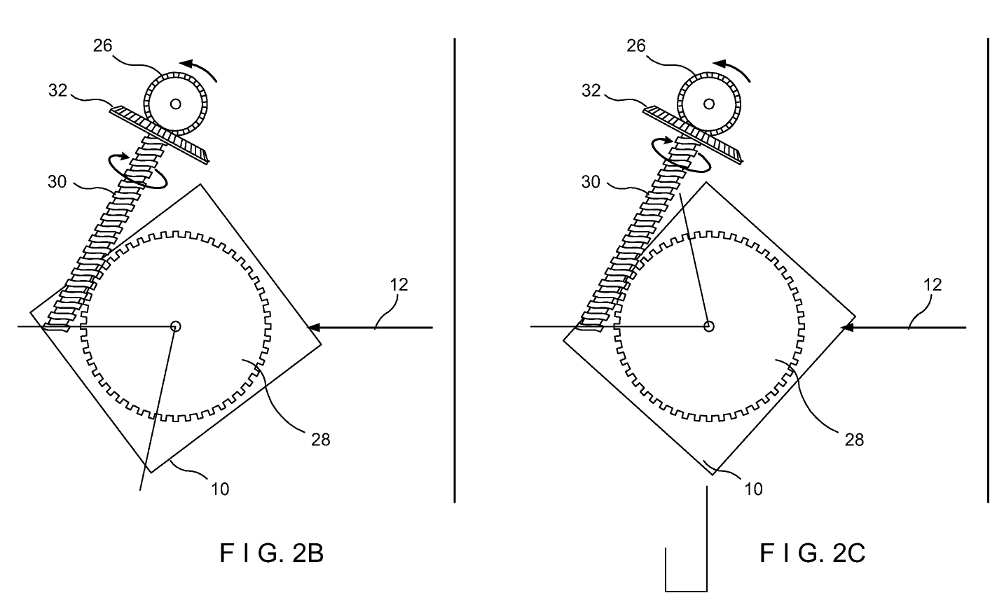

FIGS. 2a-2c show the device in a top view (viewing direction is the z-axis);

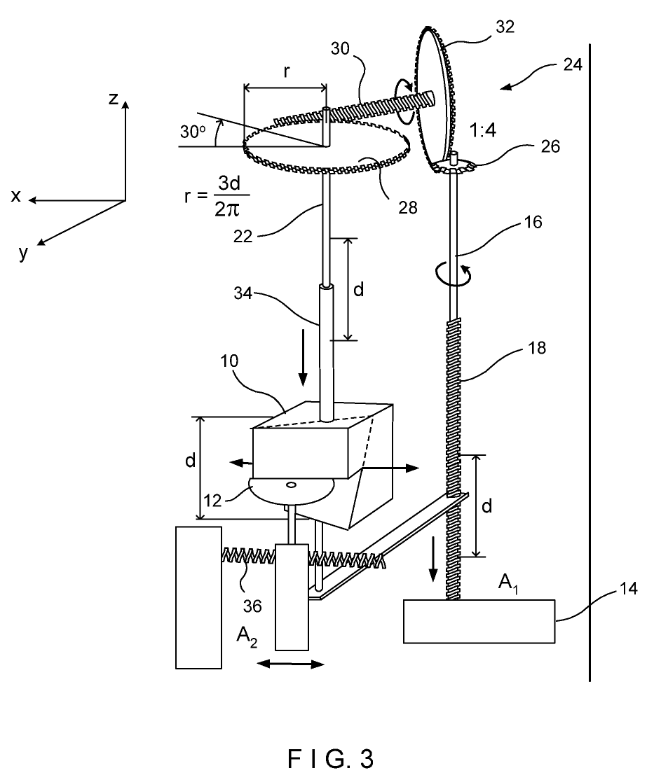

FIG. 3 shows a modification with a disk-shaped precision milling tool;

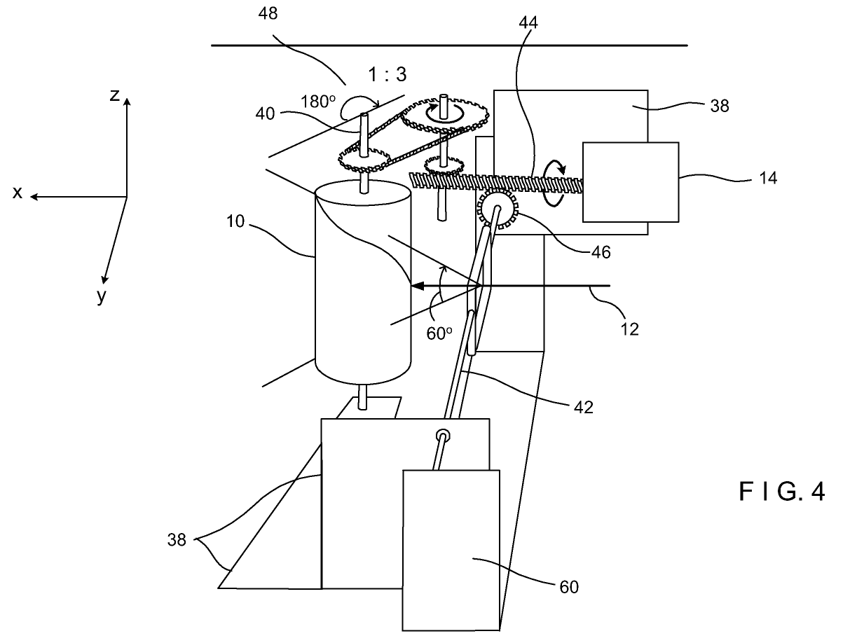

FIG. 4 shows a device for jet milling a focal point-oriented rotating cylindrical diaphragm;

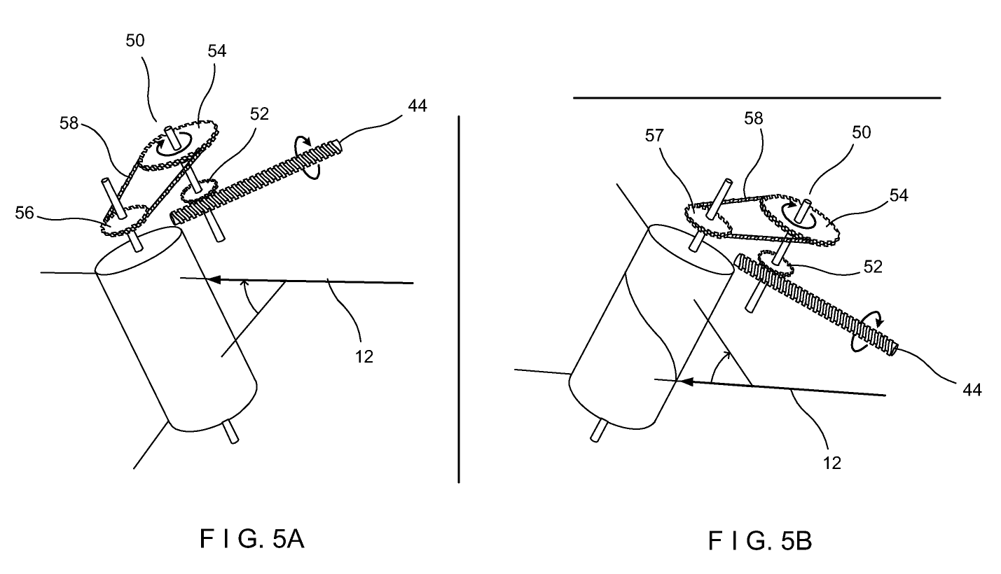

FIGS. 5a, b illustrates the operation of the gearwheel system for two orientations;

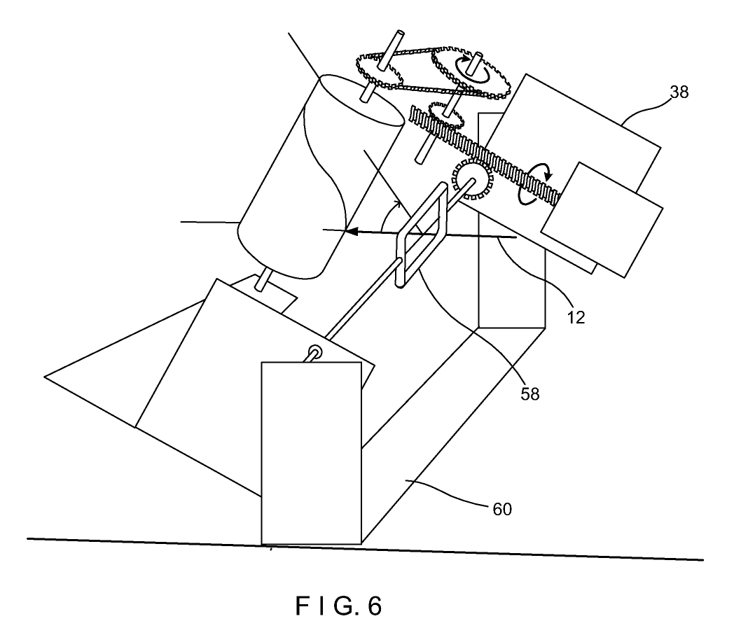

FIG. 6 shows the device in the end position of the milling process;

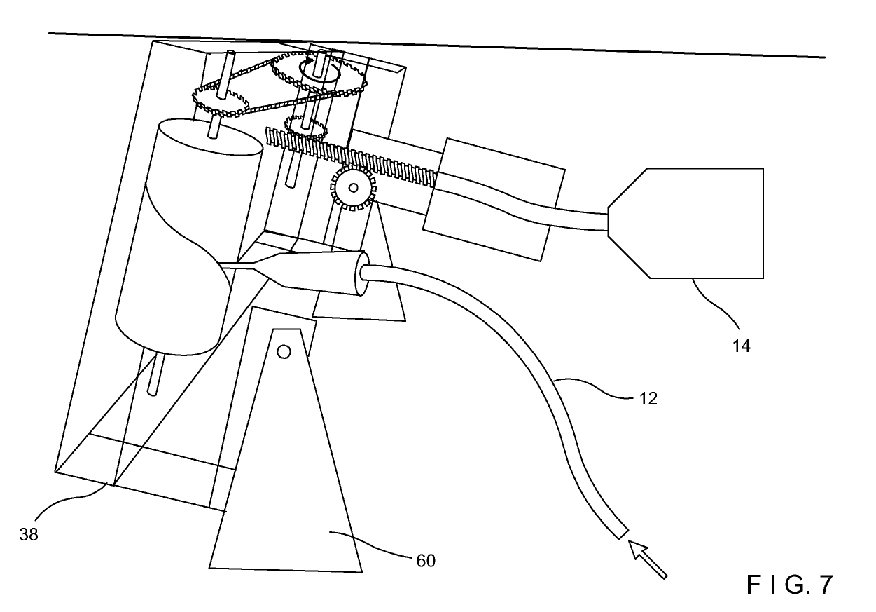

FIG. 7 shows an alternative configuration without a center axis; and

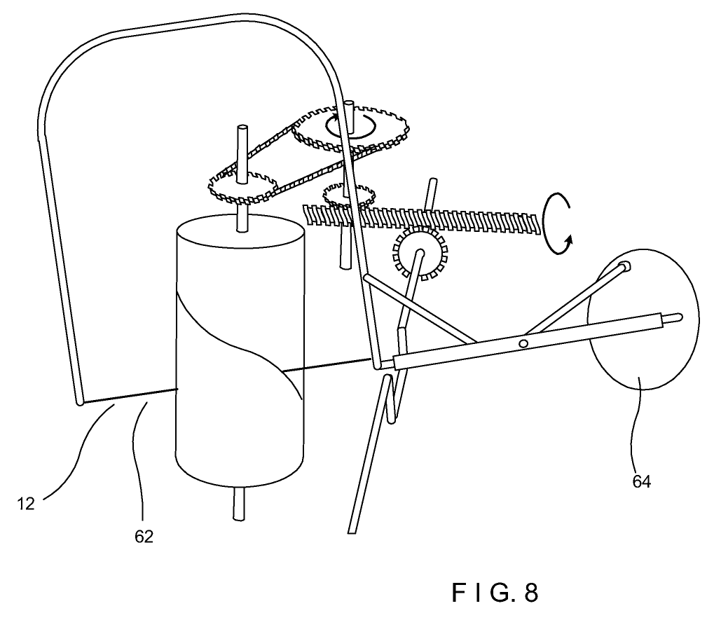

FIG. 8 shows an alternative cutting mechanism.

FIG. 1 shows a device for jet milling of a slit diaphragm made of a cube-shaped blank (semi-finished material) in a side view with a half-milled block. (Support frame and axle support have been omitted for sake of clarity). This device is suited for fabricating a slit diaphragm according to patent application DE 10 2005 029 674.2. A cube-shaped workpiece 10 is advanced both linearly and by a simultaneous rotation. Both movements have a fixed linear relationship, so that they can be coupled by a simple mechanical gear. The workpiece 10 is made of a suitable collimator material (for example, Densimet as a mechanically machineable tungsten alloy). A three-dimensional Cartesian coordinate system is also indicated in FIG. 1.

A first threaded shaft 16, which extends parallel to the z-axes, is driven by a motor 14. The first threaded shaft 16 has a region 18 formed as a worm shaft. Through mechanical interaction with the region 18, a support arm 20 arranged parallel to the y-axis is advanced parallel to the z-axis, causing a second threaded shaft 22, which is connected with the support arm 20 and arranged parallel to the z-axis, and the workpiece 10 arranged in thereon to move linearly along the z-axis. The threaded shafts 16, 22 rotate synchronously, whereby the mechanical transmission occurs by using a gearwheel system 24. The gearwheel system 24 is constructed of two gearwheels (spur wheels or bevel wheels) 26, 28, which are supported on the two threaded shafts 16, 22, as well as a worm shaft 30 arranged perpendicular to the z-axis. An additional gearwheel 32 is supported on the worm shaft 30. The worm shaft 30 drives the gear wheel 28 disposed on the second threaded shaft 22, while the rotation between the two perpendicular gear wheels 26, 32 is transmitted simultaneously. The speed in the present example is stepped down by 2:1. In this way, the rotation is transmitted to the workpiece 10 arranged on the second threaded shaft 22. Because the linear downward motion (parallel to the z-axis) is simultaneously performed, the axis of the second threaded shaft 22 must be connected with the actual workpiece holder by a telescopic tube 34, so that the rotation is transmitted without impeding the downward motion parallel to the z-axis. The gear wheel 28 in this arrangement must have a radius r of 3d/2π, i.e., approximately d/2, to cover an aperture angle of 60°, while the workpiece 10 moves downward by the distance d.

While the workpiece 10 rotates about the second threaded shaft 22 and simultaneously travels along the z-axis, a slit running parallel to the x-axes is milled in the workpiece 10 by a cutting jet 12. During the entire milling operation, the cutting jet 12 maintains the same direction (parallel to the x-axis), tracking the central beam path through the machined diaphragm in the reverse direction.

FIG. 2 shows the device of the invention in a top view (viewed along the z-axis). FIG. 2a indicates preferred dimensions for producing a slit diaphragm with an aperture angle of 60°. The workpiece 10 is here a cube with an edge length d, the radius of the gearwheel 28 is selected as r=3d/2π. The gear ratio between the perpendicularly arranged gear wheels 26 and 32 is 1:2. To illustrate the manufacturing process from the beginning to the end, FIG. 2b illustrates the initial position of the cube-shaped blank 10 from above with the future aperture angle. Accordingly, the right leg of this angle coincides with the cutting direction. The end position indicated in FIG. 2c is reached after a complete pass. The rotation and displacement directions provided in the invention can also be reversed, so that a slit with a mirror geometry can be cut. For attaining an aperture angle greater than 60° along a cutting height d, the individual gear ratios can be freely changed, as long as the total ratio satisfies the following condition:

r:d=3:(∪π) (1),

wherein r is the radius of gearwheel 28 that drives the second threaded shaft 22, d is the vertical travel, and U is the step-down ratio at the direction change provided by the two smaller gear wheels 26 and 32. The aforementioned relationship has the following meaning: a rotation of ⅙ of a complete circle (60°) must be performed along the travel d. If the periphery of an imaginary circle (2πr) continues to be rotated with the same speed as the workpiece is advanced on the axis, then it must be six times greater than the displacement distance (6d=2π) to satisfy this condition. Intermediate step-down gears can reduce the diameter of this imaginary circle to a more manageable size. The same applies if different aperture angles are desired.

The overall mechanical structure illustrated in FIGS. 1 and 2 can be mounted in a fixed frame, as long as the cutting tool 12 and the movement of the workpiece 10 are not obstructed.

FIG. 3 shows a modification of the embodiment depicted in FIGS. 1 and 2 with the cutting tool implemented as a precision milling disk. If very small radiating objects are to be imaged, for example the focal points of x-ray tubes, then the slit diaphragms must be fabricated with high precision. This may require mechanical (finish) grinding. To this end, the aforedescribed arrangement is modified by employing a precision milling disk as a cutting tool instead of a cutting jet, which can then be linearly moved back-and-forth on a rail 36. In this embodiment, only one side of the slit diaphragm is machined. Two complementarily shaped halves (having the same basic shape) are subsequently combined to form a complete slit diaphragm. By fabricating two half diaphragms, the slit width of the slit diaphragm can advantageously be adjusted later or can be configured to be adjustable. Because focal spots have a size of a few millimeters and produce intense radiation, slit widths of 100 μm or even less must be attained, which require precision grinding. The small dimensions of a focal spot and the distance from the diaphragm dictated by the size of the x-ray tube suggest that aperture angles (apertures) smaller than 60° may be desirable. This can be attained by changing the gear ratio and by including in the above condition (1) the aperture angle α:

r:d=180:(α∪) (2).

This means that in practical applications a fixed ratio exists for each aperture angle between the radius of the gearwheel 28, including the gear, and the displacement parallel to the z-axis. Accordingly, different aperture angles can be realized with the same holder by appropriately changing gear ratios.

FIG. 4 shows a device for jet milling of a focal point-oriented rotating cylindrical diaphragm as described in DE 10 2005 048 519.7-54.

Unlike with the fabrication process of a slit diaphragm illustrated in FIGS. 1 to 3, the fabrication process here requires, instead of the vertical travel, a second rotation about a rotation axis that extends through the focal point and is oriented perpendicular to the optical axis and to the symmetry axis of the rotating cylindrical diaphragm. During the milling operation, instead of a linear downward motion, a pivoting motion is performed with an angle defined by the desired aperture. According to the design described in the patent application DE 10 2005 048 519.7-54, the cylindrical workpiece must perform half a revolution, i.e., a rotation of 180° during the pivoting motion. This produces a fixed ratio for the angular advance, so that a linear, purely mechanical control is here also possible, obviating the need for programming a complex machine tool. An aperture angle of 60° requires a transmission ratio of 1:3. The slit height, which is determined by the position of the focal spot, is determined by the distance from the cylindrical blank. Also indicated in FIG. 4 is a three-dimensional Cartesian coordinate system. However, it should be noted that the orientation of certain axes is not fixed as a result of the performed rotations, but varies during the fabrication process.

The cutting jet device 10 is fixedly mounted with respect to its position and orientation, so that the cutting jet extends parallel to the x-axis during the entire fabrication process. The cylindrical workpiece 10 is disposed on a first rotation axis 40 which coincides with the symmetry axis of the cylindrical workpiece 10 and is rotatably supported in a movably supported frame 38. The movably supported frame 38 is rotatably supported about a second rotation axis 42 which extends parallel to the y-axis both perpendicular to the cutting jet direction x and also perpendicular to the first rotation axis 40. The motor 14, which drives the rotations, is fixedly installed in the movably supported frame 38. The motor 14 drives a worm shaft 44, which forms a worm gear system in conjunction with a worm gear 46 disposed on the second rotation axis 42. The worm gear 44, 46 causes the movably supported frame 38 to rotate about the second rotation axis 42. A gearwheel system 48, which rotates synchronously with the movably supported frame 38 about the second rotation axis 42, is arranged in the movably supported frame. The gearwheel system 48 transmits the drive power from motor 14 so as to produce a rotation of the first rotation axis 40.

FIGS. 5a, b illustrate the operation of the gearwheel system 48 for two orientations of the first rotation axis 40. Two gearwheels 52, 54 are arranged on a third rotation axis 50 extending parallel to the first rotation axis 40, wherein one of the gearwheels 52 forms, in conjunction with the worm shaft 44, a worm gear which effects a rotation of the third rotation axis 50. A gear chain 57 is arranged on the gearwheel 54 and on a gearwheel 56 disposed on the first rotation axis 40, wherein the gear chain 57 transmits the rotation between the first rotation axis 40 and the third rotation axis 50.

The illustrated mechanism simultaneously controls the pivoting motion of the mounting frame and the rotation of the cylindrical workpiece. To minimize mechanical stress, the rotary device must be mass-balanced about the focal axis. If the installation requires a fixed axis, then an opening in the shape of a small window 58 or a U-shaped space must be provided in the center to allow passage of the cutting jet 12.

FIG. 4 also shows the arrangement of all functional components and their support in a U-shaped support mount 60 when the milling operation is half-finished. The milling jet 12 forms the bisecting line of the aperture angle. Drive motor 14 and worm shaft 44 are arranged in the rearward section of the movable frame 38. The worm drive is initially operated by a worm gear 46 which is fixedly connected with the movable frame 38, thereby controlling the pivoting motion.

FIG. 6 shows the end position of the milling process. As illustrated, the worm gear 46 is fixedly connected on the driveshaft for the pivoting motion with the movably supported frame 38, thereby effecting the rotation of the entire interior mount including the workpiece 10 and the drive (motor 14).

FIG. 7 shows an alternative configuration, wherein on the center axis the second rotation axis 42 is completely eliminated so as to leave more space for the jet nozzle 12, and moreover a fixed motor drive 14 is provided which is connected with to holder by a flexible shaft. A commercially available drill or an electric screwdriver with adjustable rotation speed can therefore be used with this configuration.

FIG. 8 shows an arrangement with an alternative cutting mechanism. A cutting blade 12, for example of a jigsaw, is driven by an eccentric cam 64 and guided on a rail oriented in the cutting direction. By suspending this device for rotation about the focal point of the rotating cylindrical diaphragm, as indicated in the figure, then the remaining holder can be fixedly installed, which is not the case with the aforedescribed cutting jet device. This may advantageous for providing space for guiding the bow.

1. Device for producing a slit diaphragm, comprising a cutting tool (12) capable of cutting along a straight line, and means capable of effecting a relative movement between the cutting tool (12) and a workpiece (10), such that the cutting tool (12) cuts the workpiece (10) along a line which corresponds a beam path in the slit diaphragm to be produced.

2. Device according to claim 1, wherein the cutting tool (12) is adapted to cut along a fixed first direction (x).

3. Device according to claim 2, wherein the cutting tool (12) is immovably arranged.

4. Device according to claim 2, wherein the means comprise a holder on which a workpiece (10) can be attached and which is supported for rotation about a first rotation axis (22, 40).

5. Device according to claim 4, wherein the first rotation axis extends along a second direction (z) perpendicular to the cutting direction (x) of the cutting tool (12), and that the means are configured to effect a rotation of the holder (22) about the first rotation axis and simultaneously a translation of the holder (22) along the second direction (z).

6. Device according to claim 5, wherein the rotation and the translation of the holder (22) are linearly coupled.

7. Device according to claim 6, wherein the means comprise a first and a second threaded shaft (16, 22), both of which extending in the second direction (z), wherein a rotation of the two threaded shafts (16, 22) is coupled by a gearwheel system (24).

8. Device according to claim 7, wherein the first threaded shaft (16) has a region (18) formed as a worm shaft, with which a holding arm (20), to which the second threaded shaft (22) is connected, can be moved along the second direction (z).

9. Device according to claim 4, wherein the means are configured to effect a rotation of the holder (22) about the first rotation axis and simultaneously a rotation of the first rotation axis, including the holder (22), about a second rotation axis (42).

10. Device according to claim 9, wherein the two rotations are linearly coupled with one another.

11. Device according to claim 9, wherein the second rotation axis (42) extends along a third direction (y) perpendicular to the cutting direction (x) of the cutting tool (12).

12. Device according to claim 9, wherein the means comprise a movably supported frame (38), which is rotatably supported for rotation about the second rotation axis (42) and in which the first rotation axis (40) is rotatably supported.

13. Method for producing a slit diaphragm, wherein a relative movement between a cutting tool (12), which is configured to cut along a straight line, and a workpiece (10) is performed in such a way, that the cutting tool (12) cuts the workpiece (10) along a line which corresponds to the beam path in the slit diaphragm to be produced.

14. Method according to claim 13, wherein the workpiece (10) is cut along a fixed first direction (x).

15. Method according to claim 14, wherein a rotation of the workpiece (10) about a first rotation axis, which extends along a second direction (z) perpendicular to the cutting direction (x) of the cutting tool (12), and simultaneously a translation of the workpiece (10) along the second direction (z) are performed.

16. Method according to claim 14, wherein the rotation and the translation of the workpiece (10) are linearly coupled.

17. Method according to claim 14, wherein a rotation of the workpiece (10) about a first rotation axis (40) and simultaneously a rotation of the first rotation axis (40), including the workpiece (10), about a second rotation axis (42) are performed.

18. Method according to claim 17, wherein the two rotations are linearly coupled with one another.
